(19) United States
(12) Patent Application Publication
(10) Pub. No.: US 2012/0158377 A1
(43) Pub. Date: Jun. 21, 2012

(54) METHOD AND APPARATUS FOR SEARCHING FOR NEIGHBORING PARTICLES BY USING TEMPORAL CONTINUITY

(75) Inventors: Soon Hyoung PYO, Daejeon (KR); BONKI KOO, Daejeon (KR)

(73) Assignee: Electronics and Telecommunications Research Institute, Daejeon (KR)

(21) Appl. No.: 13/310,067

(22) Filed: Dec. 2, 2011

(30) Foreign Application Priority Data
Dec. 17, 2010 (KR) 10-2010-0130303

(51) Int. Cl. G06F 7/60

(52) U.S. Cl. 703/2

(57) ABSTRACT

A method for searching for neighboring particles includes: setting neighbor target particles of a current particle to calculate mutual influences between the neighbor target particles and the current particle; selecting neighboring particles depending on a calculation result of the mutual influences to store indexes of the neighboring particles in the current particle; updating locations and information of the current particle based on power of the mutual influences and proceeding to a next time step; determining the neighboring particles selected at a previous time step as the neighbor target particles; and repeating above steps starting from said calculating mutual influences regarding the newly determined neighbor target particles.

### CROSS-REFERENCE(S) TO RELATED APPLICATION(S)

The present invention claims priority of Korean Patent Application No. 10-2010-0130303, filed on Dec. 17, 2010, which is incorporated herein by reference.

### FIELD OF THE INVENTION

The present invention relates to searching for a neighboring particle by using temporal continuity, and more particularly, to a method and apparatus for searching for neighboring particles by using temporal continuity, which are capable of quickly searching for neighboring particles in a particle-based physical simulation such as a fluid, a rigid body, a deformed body, or the like.

### BACKGROUND OF THE INVENTION

Recently, a method using a particle is frequently used in a computer simulation for reproducing a physical phenomenon such as a fluid, a rigid body, a deformed body, or the like.

In the particle-based physical simulation, an object desired to be simulated is made into particles and movements of the particles are calculated while performing simulation by a very small period of time. The very small period of time is referred to as a time step.

Further, in the particle-based physical simulation, mutual influences between freely moving particles are calculated, and for this, a scheme is necessary for quickly searching for neighboring particles located around a current particle.

The scheme in the conventional art, which is shown in FIG. 1, is performed as follows: a space where a simulation is made is divided in advance; particles included in each area are searched at every time step to update information; and mutual influences between a current particle being calculated and particles included in an area adjacent to an area to which the current particle belongs are calculated in the simulation.

Thus, it is required at every time step to search the entire particles and update information, and this leads to degradation of simulation performance. Such a scheme of updating information of particles included in each area at every time step has such a common problem, even if there is a difference in performance depending on a manner dividing a simulation space.

### SUMMARY OF THE INVENTION

In view of the above, the present invention provides a method and an apparatus for searching for neighboring particles, which enable quick search of neighboring particles by searching for particles located nearby in consideration of temporal continuity of movements of particles while a physical simulation is ongoing.

In accordance with a first aspect of the present invention, there is provided a method for searching for neighboring particles, the method including:

setting first neighbor target particles of a current particle to calculate first mutual influences between the first neighbor target particles and the current particle;

selecting first neighboring particles among the first neighbor target particles depending on a result of the calculation of the first mutual influences to store indexes of the first neighboring particles in the current particle;

updating locations and information of the current particle and the first neighbor target particles based on power of the first mutual influences and proceeding to a next time step;

determining the first neighboring particles selected at a previous time step as second neighbor target particles to calculate second mutual influences between the second neighbor target particles and the current particle;

selecting second neighboring particles among the second neighbor target particles depending on a result of the calculation of the second mutual influences to store indexes of the second neighboring particles in the current particle; and

updating locations and information of the current particle and the second neighbor target particles based on power of the second mutual influences.

In accordance with a second aspect of the present invention, there is provided a method for searching for a neighboring particle, the method including:

setting first neighbor target particles of a current particle to calculate first mutual influences between the first neighbor target particles and the current particle;

selecting first neighboring particles among the first neighbor target particles depending on a result of the calculation of the first mutual influences to store indexes of the first neighboring particles in the current particle;

updating locations and information of the current particle and the first neighbor target particles based on power of the first mutual influences and proceeding to a next time step; and

checking a neighbor searching setting condition indicating an expansion range of neighbor searching targets,

wherein if a current neighbor searching corresponds to a primary setting within the neighbor searching setting condition, the method further comprises:

determining, the first neighboring particles selected at a previous time step as second neighbor target particles to calculate second mutual influences between the second neighbor target particles and the current particle;

selecting second neighboring particles among the second neighbor target particles depending on a result of the calculation of the second mutual influences to store indexes of the second neighboring particles in the current particle; and

updating locations and information of the current particle and the second neighbor target particles based on power of the second mutual influences.

In accordance with a third aspect of the present invention, there is provided an apparatus for searching for neighboring particles, the apparatus including:

a neighbor searching unit for determining neighbor target particles of a current particle;

a neighbor setting unit for setting neighboring particles based on a calculation result of mutual influences between the current particle and the neighbor target particles;

a neighbor information storage unit for storing indexes of the set neighboring particles in current particles; and

a particle location updating unit for updating locations and information of the current particle and the neighbor target particles based on power of the mutual influences.

### BRIEF DESCRIPTION OF THE DRAWINGS

The objects and features of the present invention will become apparent from the following description of embodiments, given in conjunction with the accompanying drawings, in which:

FIG. 1 is a view showing an example of a method for searching for neighboring particles according to the prior art;

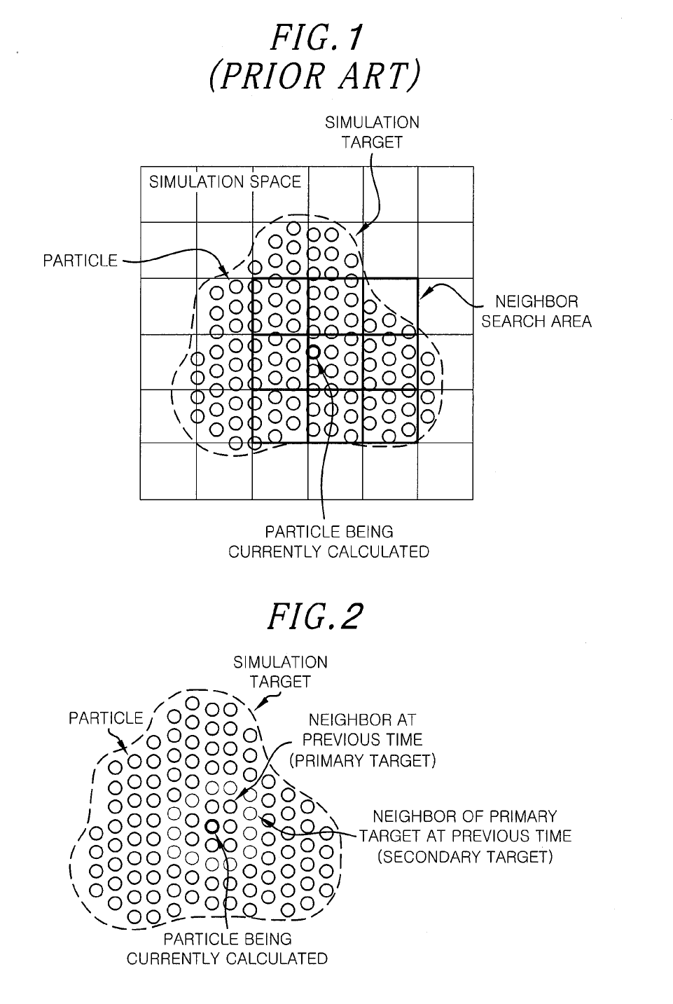

FIG. 2 is a view showing an example of a method for searching for neighboring particles by using temporal continuity in accordance with an embodiment of the present invention;

FIG. 3 illustrates a block diagram of an apparatus for searching for neighboring particles by using temporal continuity in accordance with the embodiment of the present invention;

FIG. 4 illustrates a flow chart for explaining a first example of a method for searching for neighboring particles by using temporal continuity in accordance with the embodiment of the present invention; and

FIG. 5 illustrates a flow chart for explaining a second example of a method for searching for neighboring particles by using temporal continuity in accordance with the embodiment of the present invention.

### DETAILED DESCRIPTION OF THE EMBODIMENTS

Hereinafter, embodiments of the present invention will be described in detail with the accompanying drawings.

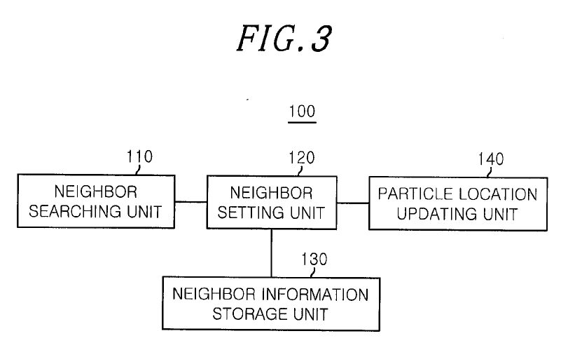

FIG. 2 is a view showing an example of a method for searching for neighboring particles by using temporal continuity in accordance with an embodiment of the present invention, wherein neighboring particles being targeted for calculating mutual influence are expanded.

In a simulation using a computer, since stability of the simulation is degraded as a time step is large, a small time step is maintained, and a moving distance of particles calculated at each time step is limited accordingly. Thus, particles which are adjoining at a current time step are also highly likely to be neighbors each other at a next time step.

Based on such characteristics, the present invention searches for neighboring particles at a next time step by using neighbor information at a previous time step. When neighbors of a particular particle are searched, first, neighboring particles which had adjoined the particular particle at a previous time step are taken as first targets and mutual influences between the first targets and the particular particle are calculated. As occasion demands, particles which had adjoined the neighboring particles at a further previous time step are taken as second targets and mutual influences between the second targets and the particular particle are calculated. Targets may be expanded in that manner, and the expansion range of targets may be designated by a user as necessary in order to enhance accuracy of the simulation calculation.

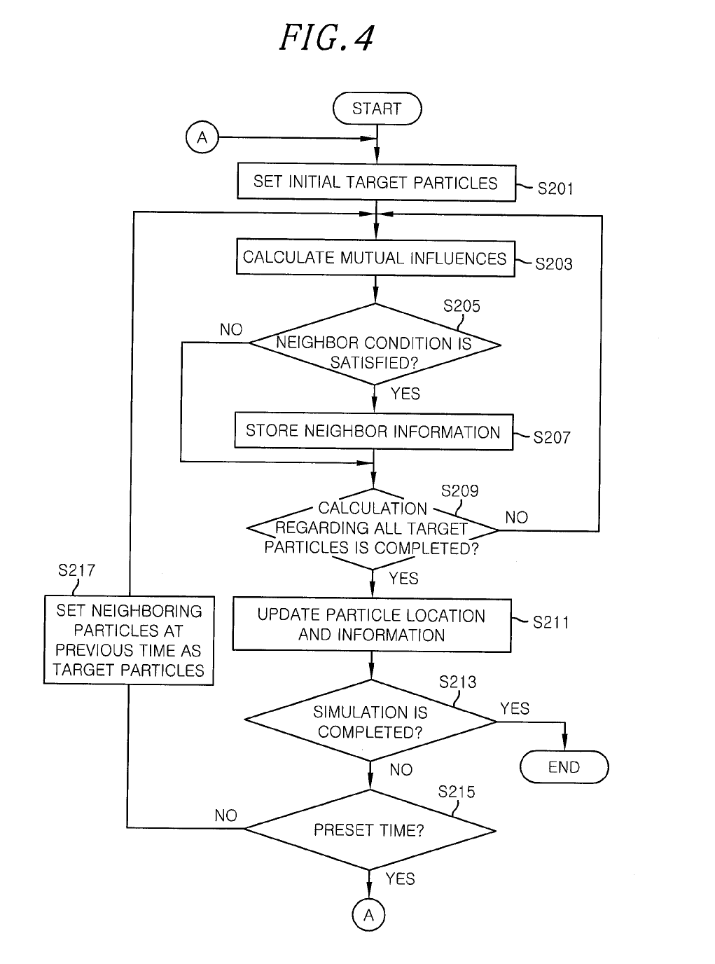

FIG. 3 illustrates a block diagram of an apparatus for searching for neighboring particles by using temporal continuity in accordance with the embodiment of the present invention.

Referring to FIG. 3, the apparatus 100 for searching for neighboring particles includes a neighbor searching unit 110, a neighbor setting unit 120, a neighbor information storage unit 130 and a particle location updating unit 140.

The neighbor searching unit 110 determines particles to be taken as targets of a neighbor of a current particle (hereinafter, referred to as neighbor target particles). In detail, the neighbor searching unit 110, when there is no neighbor information of a previous time step or when a preset time has lapsed, first sets neighbor target particles by using a space division scheme or the like. Except the above case, the neighbor searching unit 110 determines neighboring particles selected at a previous time step as the neighbor target particles. If the expansion range of the targets has been designated as a primary range, the neighbor searching unit 110 may determine neighboring particles selected at a previous time step as the neighbor target particles. If the expansion range of the targets has been designated as a secondary or higher range, the neighbor searching unit 110 may determine neighboring particles selected at a previous time step of current neighboring particles, as the neighbor target particles.

The neighbor setting unit 120 sets neighboring particles based on a calculation result of mutual influences between the current particle and the neighbor target particles.

The neighbor information storage unit 130 stores indexes of the neighboring particles set by the neighbor setting unit 120 in the current particle.

The particle location updating unit 140 updates, when the calculation of the mutual influences with respect to all the neighbor target particles is completed, locations and information of the current particle and the neighbor target particles based on the power of influences.

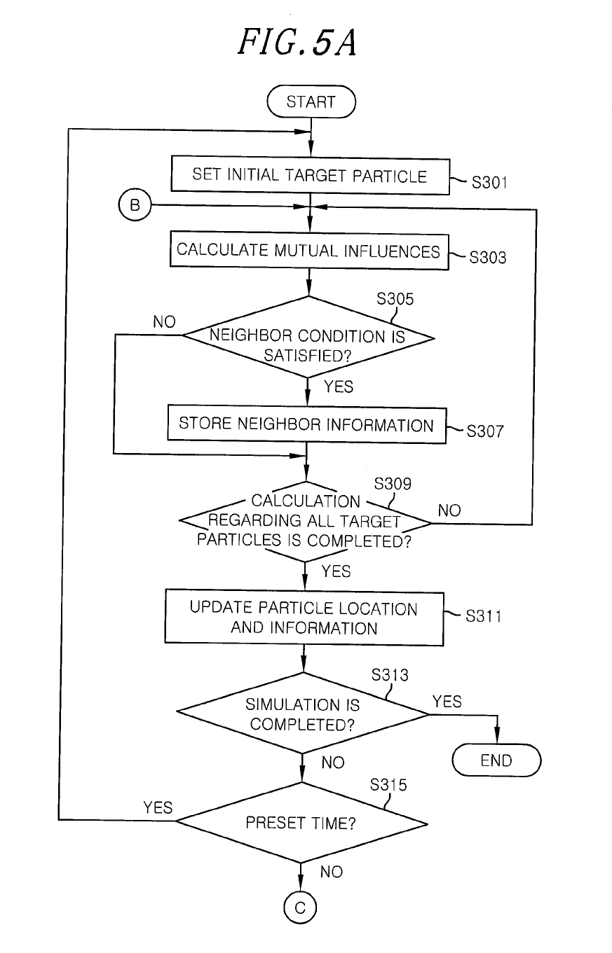

FIG. 4 illustrates a flow chart for explaining a first example of a method for searching for neighboring particles by using temporal continuity in accordance with the embodiment of the present invention.

Referring to FIG. 4, when a simulation starts, since there is no neighbor information of a previous time step, neighbor target particles of a current particle are first set by using a space division scheme, or the like in step S201. Thereafter, mutual influences between the neighbor target particles and the current particle are calculated in step S203. If the mutual influence calculation result meets a predetermined neighbor condition in step S205, namely, if any of the neighbor target particles are in a sufficiently adjacent location to the current particle, the any of the neighbor target particles are selected as neighboring particles and indexes thereof are stored in the current particle in step S207.

When the calculation of mutual influences with respect to all the neighbor target particles is completed in step S209, locations and information of the current particle and the neighbor target particles are updated based on the power of influences in step S211.

Next, in step S213, it is determined whether the simulation is completed or not. If the simulation needs to go on, it is determined in step S215 whether a preset time has lapsed. If the preset time has not lapsed yet, the process goes to a next time step.

Starting from a second time step, neighbors are expanded based on information of previously selected neighbors and mutual influences with regard to the expanded neighbors are calculated. Namely, the neighboring particles at the previous time step are set as the neighbor target particles in step S217, and steps S203 to S211 are again performed on the set neighbor target particles.

Meanwhile, when neighbor information is lost like a case of a particle showing abnormally large movements by a strong power or a splash particle which is out of the surface of water in a fluid, the particle may be missing in a subsequent calculation. This problem may be solved by performing the initial neighbor setting process at preset time intervals. To this end, if it is determined in step S215 that the preset time has lapsed while neighboring particles are being searched, the process returns to step S201 to reset the neighbor target particles by using the space division scheme, or the like.

This neighboring particle searching process is performed until the simulation is completed in step S213.

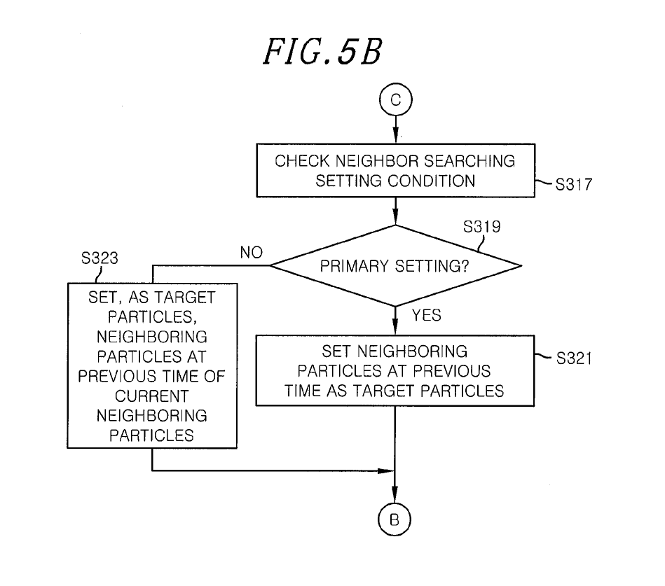

FIG. 5 illustrates a flow chart for explaining a second example of a method for searching for neighboring particles by using temporal continuity in accordance with the embodiment of the present invention.

In the second example, it is assumed that an expansion range of neighbor searching targets has been designated by a user.

Referring to FIG. 5, when a simulation starts, since there is no neighbor information of a previous time step, neighbor target particles of a current particle are first set by using a space division scheme, or the like in step S301. Thereafter, mutual influences between the neighbor target particles and the current particle are calculated in step S303. If the mutual influence calculation result meets a predetermined neighbor condition in step S305, namely, if any of the neighbor target particles are in a sufficiently adjacent location to the current particle, the any of the neighbor target particles are selected as neighboring particles and indexes thereof are stored in the current particle in step S307.

When the calculation of mutual influences with respect to all the neighbor target particles is completed in step S309, locations and information of the current particle and the neighbor target particles are updated based on the power of influences in step S311.

Next, in step S313, it is determined whether the simulation is completed or not. If the simulation needs to go on, it is determined in step S315 whether a preset time has lapsed. If the preset time has not lapsed yet, the process goes to a next time step.

In the next time step, a neighbor searching setting condition is checked in step S317. The neighbor searching setting condition indicates an expansion range of neighbor searching targets and this determines the accuracy of simulation calculation. When the current neighbor searching corresponds to a primary setting in step S319, the neighboring particles at the previous time step are set as the neighbor target particles in step S321, likewise as in the first example described above, in order to calculate neighbors at a new time step by utilizing neighbor information at the previous time step. Thereafter, the process returns to step S303 to calculate mutual influences with regard to the set neighbor target particles.

Meanwhile, when it is determined in step S315 that the preset time has lapsed while neighboring particles are being searched, the process returns to step S301 to reset the neighbor target particles by using the space division scheme, or the like. In this wise, the problem of missing particles due to lost neighbor information can be solved, as described above.

When the current neighbor searching corresponds to a secondary or higher setting within the neighbor searching setting condition in step S319, neighboring particles selected at a previous time step of current neighboring particles are set as the neighbor target particles in step S323 and the process returns to step S303.

The neighboring particle searching process is performed until the simulation is completed in step S313.

In accordance with the embodiment of the present invention, the simulation performance can be remarkably improved by minimizing the time taken to search neighboring particles which is one of elements requiring much time in a particle-based physical simulation. Further, the accuracy of neighbor searching and the speed of simulation can be adjusted depending on a searching setting condition designated by a user.

While the invention has been shown and described with respect to the embodiments, it will be understood by those skilled in the art that various changes and modification may be made without departing from the scope of the invention as defined in the following claims.

What is claimed is:

1. A method for searching for neighboring particles, the method comprising:
setting first neighbor target particles of a current particle to calculate first mutual influences between the first neighbor target particles and the current particle;
selecting first neighboring particles among the first neighbor target particles depending on a result of the calculation of the first mutual influences to store indexes of the first neighboring particles in the current particle;
updating locations and information of the current particle and the first neighbor target particles based on power of the first mutual influences and proceeding to a next time step;
determining the first neighboring particles selected at a previous time step as second neighbor target particles to calculate second mutual influences between the second neighbor target particles and the current particle;
selecting second neighboring particles among the second neighbor target particles depending on a result of the calculation of the second mutual influences to store indexes of the second neighboring particles in the current particle; and
updating locations and information of the current particle and the second neighbor target particles based on power of the second mutual influences.

2. The method of claim 1, further comprising:
performing, when a preset time has lapsed, all the steps again starting from said setting the first neighbor target particles.

3. A method for searching for a neighboring particle, the method comprising:
setting first neighbor target particles of a current particle to calculate first mutual influences between the first neighbor target particles and the current particle;
selecting first neighboring particles among the first neighbor target particles depending on a result of the calculation of the first mutual influences to store indexes of the first neighboring particles in the current particle;
updating locations and information of the current particle and the first neighbor target particles based on power of the first mutual influences and proceeding to a next time step; and
checking a neighbor searching setting condition indicating an expansion range of neighbor searching targets,
wherein if a current neighbor searching corresponds to a primary setting within the neighbor searching setting condition, the method further comprises:
determining, the first neighboring particles selected at a previous time step as second neighbor target particles to calculate second mutual influences between the second neighbor target particles and the current particle;
selecting second neighboring particles among the second neighbor target particles depending on a result of the calculation of the second mutual influences to store indexes of the second neighboring particles in the current particle; and
updating locations and information of the current particle and the second neighbor target particles based on power of the second mutual influences.

4. The method of claim 3, wherein if the current neighbor searching corresponds to a secondary or higher setting within the neighbor searching setting condition, the method further comprises:
determining, the second or higher neighboring particles selected at a previous time step of current neighboring particles as third or higher neighbor target particles to calculate third or higher mutual influences between the third or higher neighbor target particles and the current particle;
selecting third or higher neighboring particles among the third or higher neighbor target particles depending on a result of the calculation of the third or higher mutual influences to store indexes of the third or higher neighboring particles in the current particle; and
updating locations and information of the current particle and the third or higher neighbor target particles based on power of the third or higher mutual influences.

5. The method of claim 4, further comprising:
performing, when a preset time has lapsed, all the steps again starting from said setting the first neighbor target particles.

6. An apparatus for searching for neighboring particles, the apparatus comprising:
a neighbor searching unit for determining neighbor target particles of a current particle;
a neighbor setting unit for setting neighboring particles based on a calculation result of mutual influences between the current particle and the neighbor target particles;
a neighbor information storage unit for storing indexes of the set neighboring particles in current particles; and
a particle location updating unit for updating locations and information of the current particle and the neighbor target particles based on power of the mutual influences.

7. The apparatus of claim 6, wherein the neighbor searching unit determines, when there is no neighbor information of a previous time step or when a preset time has lapsed, sets the neighbor target particles by using a space division scheme.

8. The apparatus of claim 6, wherein the neighbor searching unit determines, when there is neighbor information of a previous time step and when a preset time has not lapsed yet, neighboring particles selected at a previous time as the neighbor target particles.

9. The apparatus of claim 6, wherein in a case where a neighbor searching setting condition indicating an expansion range of neighbor searching targets has been designated, the neighbor searching unit sets, when a current neighbor searching corresponds to a primary setting, neighboring particles selected at a previous time step as the neighbor target particles, or sets, when the current neighbor searching corresponds to a secondary or higher setting within neighbor searching setting condition, neighboring particles selected at a previous time step of current neighboring particle as the neighbor target particles.
